(19) United States
(12) Patent Application Publication
(10) Pub. No.: US 2016/0073660 A1
(43) Pub. Date: Mar. 17, 2016

(54) THE USE OF A FEED SUPPLEMENT FOR RUMINANTS

(71) Applicant: RICH TECHNOLOGY SOLUTIONS LIMITED, North Canterbury (NZ)

(72) Inventor: Graeme Douglas COLES, Coalgate (NZ)

(21) Appl. No.: 14/888,092

(22) PCT Filed: Jun. 3, 2014
(86) PCT No.: PCT/IB2014/061899

§ 371 Date: Oct. 30, 2015

(30) Foreign Application Priority Data
Jun. 6, 2013 (NZ) 611640

(51) Int. Cl. A23K 1/18; A23K 1/175; A23K 1/14

(52) U.S. Cl. CPC A23K 1/1813; A23K 1/14; A23K 1/175

(57) ABSTRACT

The use of a feed supplement to improve the feed utilisation of a ruminant where said feed supplement is prepared by reacting a prepared precursor, which contains organic acids, with a multivalent cation source to precipitate a reaction product, where:—the prepared precursor is prepared from a plant precursor selected from the group consisting of an undried fermentation by-product, an undried fermentation product, undried acidic plant material and an undried pomace; and—the prepared precursor contains C3/C4 organic acids.

### TECHNICAL FIELD

The present invention relates to the use of a feed supplement prepared from plant material which contains organic acids, preferably this plant material is a fermentation by-product, a fermentation product, or a pomace, which is reacted with a multivalent cation source, that improves the utilisation of feed in ruminants.

### BACKGROUND ART

The use of mineral and other supplements with ruminants is well known however in most cases the action of these supplements is to redress a lack of specific dietary requirements (magnesium in the diet for example), replace a higher cost feed or provide materials with a specific action (antibiotics or enzymes for example). These supplements have specific identifiable actions without improving feed utilisation.

Acetic Acid and Propionic Acid are known to improve milk fat content and milk yield but their action does not affect feed utilization by the animal.

Any discussion of the prior art throughout the specification is not an admission that such prior art is widely known or forms part of the common general knowledge in the field.

One object of the present invention is to improve the feed utilization of a ruminant by using a feed supplement that is produced from fermentation by-products or by a fermentation process, or at least provide the consumer with a useful choice.

### DISCLOSURE OF INVENTION

The present invention provides the use of a feed supplement that improves feed utilisation prepared by reacting a prepared precursor which contains organic acids with a multivalent cation source. Preferably the organic C₃/C₄ acids make up at least 20% of the non-aqueous mass of the prepared precursor, with acetic acid making up no more than 10% of the total organic acids present.

Preferably the prepared precursor is prepared from a plant material precursor selected from the group consisting of an undried fermentation by-product, an undried fermentation product, an undried pomace and an undried acidic plant material.

Preferably the multivalent cation is selected from calcium, magnesium, iron, copper, cobalt, chromium, molybdenum and manganese.

Preferably said multivalent cation source is an oxide, carbonate, hydroxide, phosphate, halide or sulphate.

Preferably the pH of the feed supplement is between 4 and 8.

Preferably the feed supplement is fed to a ruminant. Preferably the feed supplement is fed with additional feed and/or additives.

Preferably said improved utilisation of feed results in increased milk yield or quality with no reduction in animal condition. Preferably said improved utilisation of feed results in enhanced weight gain and/or meat quality.

The present invention also includes the use of a feed supplement to improve the feed utilisation of a ruminant where said feed supplement is prepared by reacting a prepared precursor, which contains organic acids, with a multivalent cation source to precipitate a reaction product, where:
the prepared precursor is prepared from a plant precursor selected from the group consisting of an undried fermentation by-product, an undried fermentation product, an acidic plant material and an undried pomace; and
the prepared precursor contains C₃/C₄ organic acids.

The present invention further includes a method of improving the feed utilisation of a ruminant by feeding to said ruminant a feed supplement where said feed supplement is prepared by reacting a prepared precursor, which contains organic acids, with a multivalent cation source to precipitate an reaction product, where:
the prepared precursor is prepared from a plant precursor selected from the group consisting of an undried fermentation by-product, an undried fermentation product, an acidic plant material and an undried pomace; and
the prepared precursor contains C₃/C₄ organic acids.

Preferably the feed supplement makes up to 25% by mass of dry matter fed to the ruminant.

### BRIEF DESCRIPTION OF DRAWINGS

By way of example only, a preferred embodiment of the present invention is described in detail below with reference to the accompanying drawings, in which:

FIG. 1 is a flow chart showing the preparation of the feed supplement;

FIG. 2 is a block diagram showing the use of the feed supplement;

FIG. 3 is a graph showing the milk yield increase for a herd fed the feed supplement in example 1 over a herd on a similar diet without the feed supplement.

### DEFINITIONS

C₃/C₄ acids: Organic acids (e.g. amino acids, carboxylic acids, di-carboxylic acids, tri-carboxylic acids) containing 3 or 4 carbon atoms.
Feed Utilisation: Proportion of a feed which can be utilized by an animal.
Multivalent Cation: A cation with a charge of at least +2.

### BEST MODE FOR CARRYING OUT THE INVENTION

The present invention follows the discovery that feed supplements prepared by reacting a fermentation by-product or fermentation product with a multivalent cation source improved meat or milk yields and/or quality without detrimentally affecting the animals health. The improvements were greater than expected from the cation concentration or specific known compounds alone and this surprised the inventor who has carried out a number of trials to confirm the effect. At present these trials have shown some or all of the following beneficial effects:
Enhanced growth rate, and recovery of condition after calving;
Enhanced milk yield and composition;
Reduced production of methane;
Reduced faecal volume per unit of milk solids produced;
More efficient nitrogen metabolism (observed in example 1);
Enhanced weight gain and meat eating quality; and
Reduced excretion of faeces.

These effects have been observed for a diet consisting primarily of the feed supplement or a diet supplemented with the feed supplement. The results of the trials carried out will be provided after describing the preparation of the feed supplement.

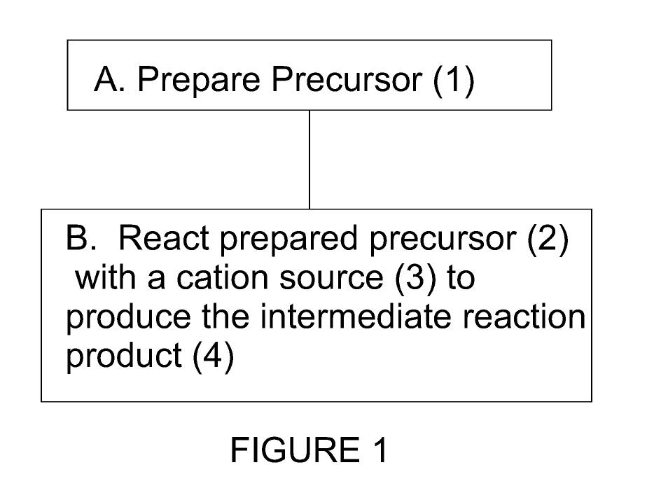

Referring to FIG. 1 the preferred method for preparing the feed supplement (3) from a precursor (1) and a cation source (2) is shown, this method includes the following steps in order:
A. Prepare precursor (1); and
B. React prepared precursor (2) with one or more multivalent cation source (3).

The precursor (1) can be any plant based material that has organic acids present, this plant based material includes plant based material that has been fermented and fermented and distilled. The list of possible materials is wide and includes marc (fruit skins, seeds etc after pressing) from grape winemaking and other fruit pomace, fermentation or distillation by-products including those from milk, rice, potato, grain, or fruit fermentation processes such as wet distillers grains (WDG), condensed distillers solubles (CDS), thin stillage, wheys, residue from grape marc distillation, etc.

The prepared precursor (2) should contain organic acids and or organic acid residues, preferably no less than 20% but as the precursor may be thin stillage this may be as low as 1% prior to concentration. In addition to the organic acid concentration one or more of the following is desirable:—
The presence of C₃ to C₆ sugars and polymers of these, this includes glycerol and esters; and/or
The presence of protein with a high Protein Efficiency Ratio (PER); and/or
The presence of non-starch polysaccharides.

With preferably 20% to 30% organic acids (of which no more than 10% of total acids present is acetic acid and the remainder is high in lactic acid or other C₃/C₄ acids), between 5% and 15% glycerol, between 5% and 50% protein and between 5% and 50% non-starch polysaccharides (with the majority being arabinoxylans of cereal origin, pectins of plant cell wall origin, and/or yeast cell wall components).

In step A the prepared precursor (2) can be prepared from the precursor (1) simply by determining relevant chemical constituents, for example the organic acid concentration and water content, and adjusting these to predetermined levels. In this case the prepared precursor (2) and precursor (1) are essentially the same. Alternatively in step A the precursor (1) may undergo one or more of the following processes to be transformed into the prepared precursor (2):—
Additional fermentation;
Blending of various precursors;
Addition of processing aids;
Addition of C₃/C₄ acids, preferably lactic acid;
Concentration adjustment by removal/addition of water.

In step B the prepared precursor (2) is reacted with a multivalent cation source (3) to form an intermediate reaction product (4). In step B at least some of the organic acids, and one or more of the following within the prepared precursor (2):—
Terminal carboxyl residues of proteins,
Acidic amino acids,
Carboxyl and other acid residues within the carbohydrate fraction, and
Other acidic residues,
   react with the multivalent cation source (3). The multivalent cation source (3) contains one or more multivalent cations which are nutritionally non-toxic at the levels used, for example Mg, Ca, Fe, Cu, Co, Mn, Zn and Mo. The reaction that occurs may involve chelating some of the organic acids, neutralising some of the acidic species, the formation of salts or chelates/complexes or simply the formation of insoluble species.

In many cases it is expected that the pH will be measured during the reaction and the addition of the multivalent cation source (3) is stopped once the desired pH is reached. It is believed that in most cases the pH will not be allowed to exceed 8 but this is yet to be confirmed. The final pH of the intermediate reaction product (4) produced is expected to be in the range of 4 to 7.5.

The multivalent cation source (3) could be a natural mineral such as limestone, dolomite, magnesite for example. However the multivalent cation source (3) could include one or more oxides, carbonates, hydroxides, chlorides, sulphates, nitrates, phosphates etc, of natural or artificial origin, of one or more multivalent cation. If natural minerals are used they need to be of sufficiently high quality to minimise any contamination of the final product.

The intermediate reaction product (4) may then be used as the feed supplement (5), that is the intermediate reaction product (4) is the reaction product, or further processing may occur. It is expected that the further processing of the intermediate reaction product (4) will include drying and size reduction. The drying can be carried out by any known means including spray drying, oven drying, microwave drying, infra-red drying and RF (radio frequency) drying, either under normal or reduced pressure (vacuum for example). The resultant material is the feed supplement (5).

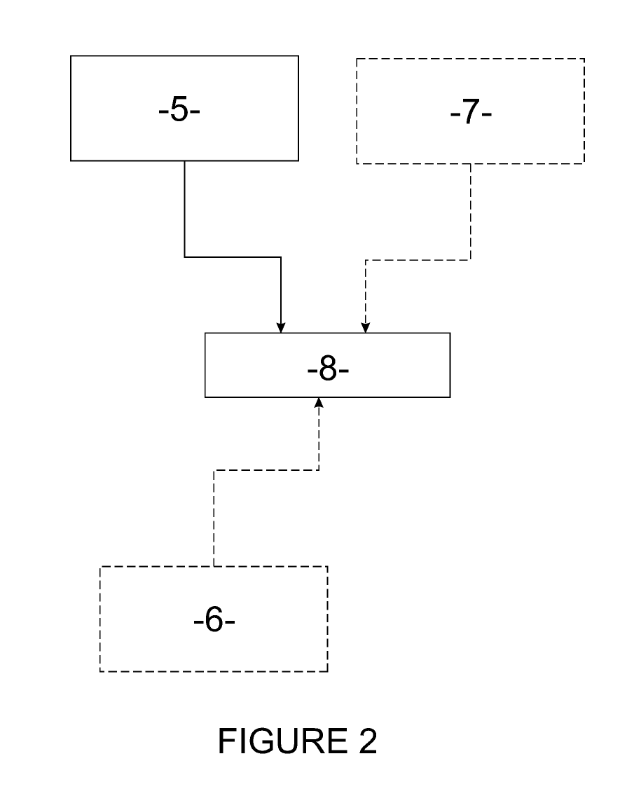

Referring to FIG. 2 the use of the feed supplement (5) is shown where the feed supplement (5) and optional materials such as additional feed (6) and/or additives (7) are fed to an animal (8)

If the feed supplement (5) has been prepared from grape marc then it may be fed as the feed to the animal (8) without further supplementation. If the feed supplement (5) has been prepared from wet distillers grain (WDG) and condensed distillers solubles (CDS) then additional feed (6) may be provided, this additional feed (6) may simply come from grazing or from silage or other animal feeds. The additives (7) could be mineral sources, antibiotics, or any other additive normally added to the diet of the animal (8).

It should be noted that Distillers Dried Grains (DDG) with the addition of multivalent cation sources are used as feed supplements but no difference in growth rate or milk yield over that expected by the energy and protein content has been observed. It is believed that the present process, and supplement prepared by the process, protects the valuable C₃/C₄ acids in the form of relatively heat stable precipitates, as such pre-dried fermentation materials such as Distillers Dried Grains (DDG) or Distillers Dried Grains and Solubles (DDGS) are unsuitable. It is believed that the precipitation of the C₃/C₄ acids means that when the feed supplement (5) is finally dried the biological activity of the acid species is preserved. The key is to add the multivalent cation source prior to any final drying of the precursor.

As the intention is to provide a friable stable feed supplement (5) it may be necessary to ‘fix’ any materials that are liquid at room temperature, for example glycerol or any other normally liquid high boiling point species, by the addition of an adsorbent/absorbent substrate for example wheat bran, hay, etc.

From trials to date it is believed that the feed supplement (5) should make up no more than 25% of the dry matter intake of the animal (8), but this is to a certain extent cost driven. It is believed that the reaction product (the final state of the intermediate reaction product (4)) should make up between 2% and 10% of the dry matter fed, though it may be determined by the recommended daily requirements of the multivalent cation.

Though the examples are limited to single multivalent cations the use of a mixture, for example a mixture containing magnesium, calcium and manganese could be used.

It should be noted that the cation source (3) could be added directly to thin stillage to form the intermediate reaction product (4). This material could then be dried or concentrated to form the feed supplement (5). The thin stillage could contain as little as 0.5% C₃/C₄ organic acids and there may be advantages to stabilising the C₃/C₄ organic acids prior to any concentration steps

It should also be noted that to standardise the process additional C₃/C₄ organic acids may be added as part of preparing the prepared precursor (2).

The precursor (1) can be an acidic plant material, where an acidic plant material has a pH of below about 5, for example lemon juice, peaches, plums, taro, tomato, apple, apricots, etc.

By way of example only the following feed supplements were prepared and trialled

### Example 1

### Supplement Supplement-Mg (LMg)

Distillers condensed solubles (DCS) syrup was collected from normal production from the facilities of Shoalhaven Starches Pty Ltd at Nowra, New South Wales, Australia, and transferred to the premises of Halcyon Products Pty Ltd in Melbourne, Victoria. Under normal conditions, DCS from this source contains approximately 25% lactic acid (dmb—dry matter basis), but this shipment was somewhat depleted in this material, so was supplemented with technical grade lactic acid (All Raw Materials Pty Ltd, Young, NSW).

The DCS was heated to 55° C., and reacted with commercial feed grade magnesium oxide (Causmag International Pty Ltd, Melbourne, Victoria) with continuous stirring and monitoring of pH. When pH reached 7, addition of magnesium oxide ceased, and the product was prepared for drying. Small-scale spray drying studies had revealed the need to incorporate a quantity of maltodextrin to improve flow properties, so 10% additional maltodextrin was mixed with the slaked DCS.

The resulting mixture was spray dried using conventional techniques, and packaged for storage and transport in 20 kg quantities in moisture-proof plastic bags in cartons. Its composition is given in table 1. (Dairy One, Inc, Ithaca, N.Y., USA)

TABLE 1
Proximate composition of Supplement-Mg (LMg)

| Component | Content as fed |
|---|---|
| Moisture (%) | 10.5 |
| Dry matter (%) | 89.5 |
| Crude protein (%) | 16.7 |
| Available protein (%) | 13.6 |
| ADICP (%) | 3.0 |
| Adjusted crude protein (%) | 14.5 |
| Acid detergent fibre (%) | 1.8 |
| Neutral detergent fibre (%) | 4.2 |
| Non-fibre carbohydrate (%) | 58.2 |
| Starch (%) | 0.5 |
| Water-soluble carbohydrates (%) | 20.1 |
| Crude fat (%) | 1.9 |
| Ash (%) | 9.44 |
| Total digestible nutrients (%) | 68.0 |
| NE_{L} (Mcal/kg) | 1.57 |
| NE_{M} (Mcal/kg) | 1.62 |
| NE_{G} (Mcal/kg) | 1.06 |
| Calcium (%) | 0.11 |
| Phosphorus (%) | 0.55 |
| Magnesium (%) | 2.82 |
| Potassium (%) | 0.93 |
| Sodium (%) | 0.782 |
| Iron (ppm) | 115.0 |
| Zinc (ppm) | 26.0 |
| Copper (ppm) | 6.0 |
| Manganese (ppm) | 57.0 |
| Molybdenum (ppm) | 1.3 |
| Sulphur (%) | 0.21 |
| Chloride ion (%) | 0.59 |
| pH | 8.6 |
| Diet cation-anion difference (mEq/100 g) | 31.0 |

### Digestible Energy was Estimated by NIR to be 14.4 MJ/Kg.

### Experimental Diet

For the purposes of this experiment, it was estimated that magnesium availability from Supplement-Mg (LMg) would be similar to availability of magnesium from magnesium chloride or sulphate, i.e. approximately 65%. Provision of 6.5 g of magnesium absorbed therefore required daily intake of sufficient Supplement-Mg (LMg) to provide a total of 10 g of magnesium, and this quantity was available from 400 g of the spray dried product.

For convenience, the 400 g of Supplement-Mg (LMg) was incorporated in 2 kg of diet, the balance consisting of 1600 g of ground locally-grown new season's winter wheat (12.2% protein dmb). This mixture was supplemented by the manufacturer (Seales Winslow Ltd, Tinwald, New Zealand) with 0.1% of the manufacturer's proprietary palatability enhancer. 19.9 t of this diet was manufactured and fed.

### Control Diet

The control diet consisted of 40 g of dairy nutritional grade magnesium oxide (Causmag International Pty Ltd, Melbourne, Victoria) in 2 kg of supplement. The supplement consisted of the same wheat as used in the experimental diet, augmented by sufficient soy bean meal (46% protein dmb) (Viterra Ltd, Auckland, New Zealand) to compensate for the difference in the protein content between the wheat and the Supplement-Mg (LMg) displaced from the experimental diet formulation. This diet was also supplemented with the same proprietary palatability enhancer. 119.0 t of this diet was manufactured and fed.

### Composition

Composition of the two supplements was determined by an independent laboratory (Nutrition Laboratory, Institute of Food, Nutrition and Human Health, Massey University, Palmerston North, New Zealand). Results are given in table 2.

TABLE 2
Supplement composition

| Analyte | Experimental | Control |
|---|---|---|
| Dry matter content (%) | 89.4 | 89.8 |
| Ash (%) | 3.1 | 3.9 |
| Protein (%) | 10.9 | 11.9 |
| Fat (%) | 1.8 | 1.6 |
| Crude fibre (%) | 2.2 | 2.4 |
| NDF (%) | 6.5 | 8.5 |
| ADF (%) | 1.2 | 1.6 |
| Calcium (g/100 g) | 0.070 | 0.100 |
| Magnesium (g/100 g) | 0.77 | 1.35 |
| ME (MJ/kg) | >13 | >13 |

### Feeding

For practical reasons, it proved necessary to provide the required magnesium to the entire herd through the feeding facilities on the rotary platform. It was for this reason that considerably more of the control diet was fed, as it was supplied to all members of the milking herd not being fed the experimental diet. Feeding of supplements commenced five days after animals were allocated to experimental groups.

### Pre-Parturition.

Animals yet to calve were maintained in a herd separate from other animals on the farm. Each day this mob of cows was brought into the milking shed, and fed their daily ration of the diets to which they were allocated.

As each cow calved, she was admitted to a post-calving group as part of the main herd, and was supplemented according to the regimen described below.

### Cows in Milk.

From calving, cows were included in the main herd. This herd was milked twice a day, and each animal received supplementation according to the group in which it was included. This took the form of 1 kg of the appropriate diet at each milking, with the addition of 100 mL of molasses to further enhance acceptability. Animals suffering adverse events (e.g. mastitis or lameness) were separated from the main herd, coming into the parlour for milking after the main herd was finished. From the end of calving, the herd began to be fed undercover untethered, so these animals suffering adverse effects were fed the same basal diet in a different pen within the main barn.

### Results and Discussion.

The target of the experiment was to provide control and experimental diets which would lead to similar nutritional and performance outcomes.

### Supplement Composition

Apart from magnesium content, the differences in composition between the experimental and control supplements were not significant, given that in both cases, the supplement provided less than 10% of total dry matter intake daily.

### Body Condition

The original group of cows prior to allocation to experimental subgroups had a range of condition scores, from several at 3.5 (significantly underweight: all cows at this score had been recently purchased) to 5 (ideal weight). Animals with an initial condition score below 4.0 were not included in the trial, and the high condition animals were observed prior to calving. As expected, calving induced a loss of condition of around about 0.5 condition score units (Sheppard, pers. comm.).

Subsequent estimations of mean body condition score showed no significant differences between groups. As expected, all animals rapidly recovered condition after calving, so that after one month of lactation, almost all animals comfortably fell into a condition score range of 4.5 to 5.0. Thus, it appears that the experimental diet caused no differences in body condition score, or the rate of recovery after calving.

### Production Data

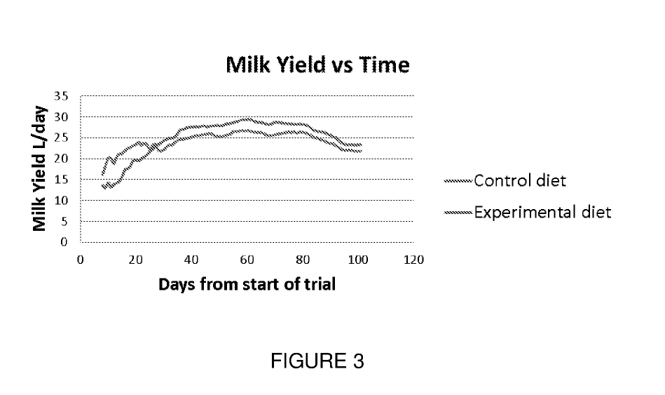

Milk production data in the form of 24 hour milk volume for each cow were collected daily. Conducting ANOVA using a General Linear Model to permit analysis of unbalanced data indicated a small but significant overall advantage in milk yield from cows on the experimental diet (25.01 L/day vs 24.21 L/day; p=0.001). However, there was a very significant interaction between diet and time (FIG. 3).

It seems possible that this interaction is due to a requirement for adaptation to one or more components of the experimental diet, but that once this adaptation is achieved, there is a sustained, significant advantage in milk yield. If the first four weeks of the trial (during which cows calved) are ignored, the interaction between diet and time disappears completely, as expected, and the advantage conveyed by the experimental diets increases (26.95 L/day vs 24.89 L/day, or 8%).

In this trial, the sampler cows were managed as a separate group. Despite the small number of animals included in this group, a similar difference between treatments remained highly significant (23.6 L/day vs 21.6 L/day (p=0.000), or 9%)

In this trial the milk quality information included a result that showed milk urea content showed a 10% difference between the control and experimental diet, indicating a similar improvement in nitrogen metabolism in the experimental diet fed animals.

### Example 2

This trial was conducted in the same broad environment as example one, except that it was carried out in the spring instead of the autumn, and the cows were fed pasture instead of conserved forage. Nearly three times as many cows were used in this trial as in trial one, and once again, a small, but significant, increase in milk yield was obtained. In contrast to the first trial, this trial also showed a substantial increase in milk solid concentration, giving a 13% increase in milk solid yield. This result was quite unexpected. Surprisingly this increase persisted for two months after the feeding of the Supplement-Mg (LMg) had ceased.

### Example 3

In a preliminary study, red grape marc from Pinot Noir wine production was offered to a herd of 50 Aberdeen Angus finisher steers for a period of 3 months prior to slaughter, as a supplement to mixed hay and winter grazing. All animals accepted the product well, eating the daily ration as soon as it was offered. At slaughter, the mean daily weight gain for the group of animals was 1.86 kg, compared to 1.5 kg for animals conventionally grazed by the same manager. When offered for sale through conventional market channels, the herd made premium prices, and the carcase quality was judged to be exceptional.

Therefore, in the following year, Pinot Noir marc was conserved by ensiling with a commercial enzyme blend normally used for the preservation of kiwifruit pomace. pH was adjusted with calcium carbonate to suit the requirements of the enzyme preparation. On completion of the secondary fermentation, which caused an increase in the level of lactic acid in the material, the conserved marc was fed as above. In this case, almost exactly the same mean weight gain was achieved, despite a period of extremely cold weather during the trial. A representative animal was independently selected from the trial for entry into a “paddock to plate” competition. Among 42 animals, the steer chosen was judged second in the competition for conformation, eighth for carcase quality (premium cuts were too large), and second for eating quality, coming third overall. Throughout the two seasons of the trial, no adverse events were observed to have occurred.

### KEY

1. Precursor;
2. Prepared precursor;
3. Cation Source;
4. Intermediate reaction product;
5. Feed supplement;
6. Additional Feed;
7. Additive;
8. Animal;

1. The use of a feed supplement to improve the feed utilisation of a ruminant where said feed supplement is prepared by reacting a prepared precursor, which contains organic acids, with a multivalent cation source to precipitate a reaction product, where:
the prepared precursor is prepared from a plant precursor selected from the group consisting of an undried fermentation by-product, an undried fermentation product, undried acidic plant material and an undried pomace; and
the prepared precursor contains C₃/C₄ organic acids.

2. The use of a feed supplement as claimed in claim 1 where the feed supplement makes up to 25% by mass of dry matter fed to the ruminant.

3. A method of improving the feed utilisation of a ruminant by feeding to said ruminant a feed supplement where said feed supplement is prepared by reacting a prepared precursor, which contains organic acids, with a multivalent cation source to precipitate a reaction product, where:
the prepared precursor is prepared from a plant precursor selected from the group consisting of an undried fermentation by-product, an undried fermentation product, undried acidic plant material and an undried pomace; and
the prepared precursor contains C₃/C₄ organic acids.

4. The method as claimed in claim 3 where the feed supplement makes up to 25% by mass of dry matter fed to the ruminant.

5. The method as claimed in claim 3, wherein, the multivalent cation is selected from the group consisting of calcium, magnesium, iron, copper, cobalt, chromium, molybdenum and manganese.

6. The method as claimed in claim 3, wherein, said improved utilisation of feed results in increased milk yield or quality with no reduction in animal condition.

7. The method as claimed in claim 4, wherein, the multivalent cation is selected from the group consisting of calcium, magnesium, iron, copper, cobalt, chromium, molybdenum and manganese.

8. The use as claimed in claim 1, wherein, the multivalent cation is selected from the group consisting of calcium, magnesium, iron, copper, cobalt, chromium, molybdenum and manganese.

9. The use as claimed in claim 2, wherein, the multivalent cation is selected from the group consisting of calcium, magnesium, iron, copper, cobalt, chromium, molybdenum and manganese.

10. The method as claimed in claim 4, wherein, said improved utilisation of feed results in increased milk yield or quality with no reduction in animal condition.

11. The use as claimed in claim 1, wherein, said improved utilisation of feed results in increased milk yield or quality with no reduction in animal condition.

12. The use as claimed in claim 2, wherein, said improved utilisation of feed results in increased milk yield or quality with no reduction in animal condition
